(19) United States
(12) Patent Application Publication
(10) Pub. No.: US 2013/0176853 A1
(43) Pub. Date: Jul. 11, 2013

(54) Apparatus and Method for Communication

(71) Applicant: Christian Mahr, Ulm (DE)

(72) Inventor: Christian Mahr, Ulm (DE)

(73) Assignee: Nokia Siemens Networks Oy, Espoo (FI)

(21) Appl. No.: 13/821,021

(22) PCT Filed: Sep. 6, 2010
(86) PCT No.: PCT/EP2010/063047

§ 371 Date: Mar. 6, 2013

(51) Int. Cl. H04W 36/22

(52) U.S. Cl. CPC H04W 36/22
USPC 370/236

(57) ABSTRACT

Apparatus and method for communication are provided. In the method, information on the amount of traffic of a mobile terminal is obtained. The value of a handover parameter for the mobile terminal is determined on the basis of the traffic level.

### FIELD

The exemplary and non-limiting embodiments of the invention relate generally to wireless communication networks. Embodiments of the invention relate especially to an apparatus and a method in communication networks.

### BACKGROUND

The following description of background art may include insights, discoveries, understandings or disclosures, or associations together with disclosures not known to the relevant art prior to the present invention but provided by the invention. Some of such contributions of the invention may be specifically pointed out below, whereas other such contributions of the invention will be apparent from their context.

Wireless radio access technologies are constantly being developed. The developed networks include UMTS (Universal Mobile Telecommunications System), LTE (Long Term Evolution) and LTE-Advanced, for example. One typical feature in the development of new radio access technologies is that also new services are being developed. Some of these services change the traffic characteristics in radio networks dramatically and have heavy influence to current and future networks.

The mobile terminals, denoting hereafter any kind of user equipment of the radio networks are capable of performing various actions related to Internet services, for example. Besides the normal traffic such as voice call and download or interactive internet browsing, there are new autonomous applications in the mobile terminals which tend to generate relatively low traffic volumes, but do this in regular intervals all the time, also without user attention. This kind of traffic increases the number of handovers in a system as the number of mobile terminals having an active RRC (Radio Resource Control) connection with the system increases.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to a more detailed description that is presented later.

According to an aspect of the present invention, there is provided an apparatus, comprising: at least one processor and at least one memory including a computer program code, wherein the at least one memory and the computer program code are configured to, with the at least one processor, cause the apparatus at least to: obtain information on the amount of traffic of a mobile terminal and determine the value of a handover parameter for the mobile terminal on the basis of the traffic level.

According to another aspect of the present invention, there is provided a method comprising: obtaining information on the amount of traffic of a mobile terminal and determining the value of a handover parameter for the mobile terminal on the basis of the traffic level.

According to an aspect of the present invention, there is provided an apparatus, comprising: means for obtaining information on the amount of traffic of a mobile terminal and means for determining the value of a handover parameter for the mobile terminal on the basis of the traffic level.

According to another aspect of the invention, there is provided a computer program embodied on a distribution medium, comprising program instructions which, when loaded into an electronic apparatus, are configured to control the apparatus to obtain information on the amount of traffic of a mobile terminal and determine the value of a handover parameter for the mobile terminal on the basis of the traffic level.

### LIST OF DRAWINGS

Embodiments of the present invention are described below, by way of example only, with reference to the accompanying drawings, in which

FIGS. 1A and 1B show simplified block diagrams illustrating examples of system architectures;

FIG. 2 illustrates an example of an apparatus;

FIG. 3 illustrates an embodiment of the invention; and

FIGS. 4A, 4B, 5A and 5B are flow charts illustrating embodiments of the invention.

### DESCRIPTION OF SOME EMBODIMENTS

Exemplary embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Embodiments of present invention are applicable to any communication system or any combination of different communication systems utilizing handovers and where it is possible to obtain information on the traffic level of a mobile terminal. The communication system may be a wireless communication system or a communication system utilizing both fixed networks and wireless networks. The protocols used and the specifications of communication systems, servers and user terminals, especially in wireless communication, develop rapidly. Such development may require extra changes to an embodiment. Therefore, all words and expressions should be interpreted broadly and are intended to illustrate, not to restrict, the embodiment.

Wireless communication systems are constantly under development. Developing systems provide a cost-effective support of high data rates and efficient resource utilization. One communication system under development is the 3rd Generation Partnership Project (3GPP) Long Term Evolution (LTE). An improved version of the Long Term Evolution radio access system is called LTE-Advanced (LTE-A). The LTE is designed to support various services, such as high-speed data, multimedia unicast and multimedia broadcast services.

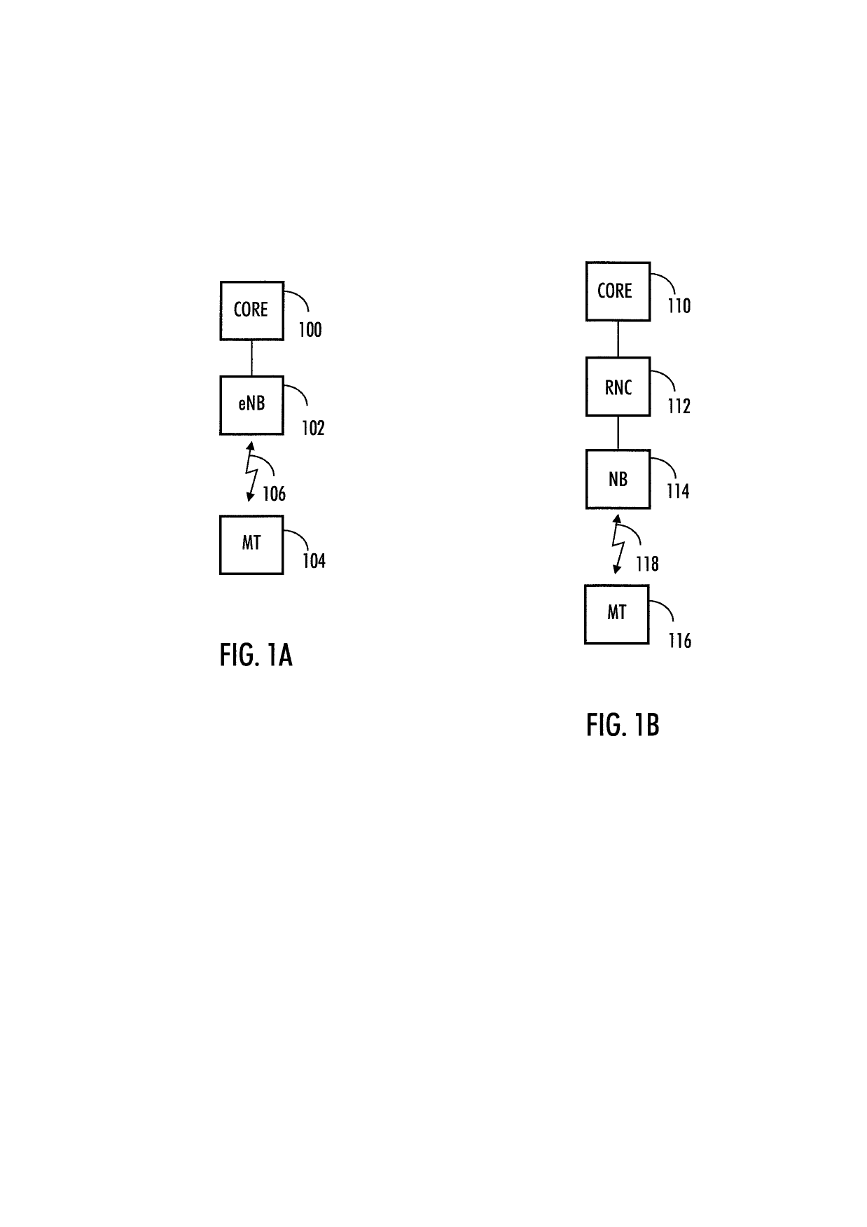

With reference to FIG. 1A, let us examine an example of a radio system to which embodiments of the invention can be applied. In this example, the radio system is based on LTE network elements. However, the invention described in these examples is not limited to the LTE radio systems.

FIG. 1A is a simplified system architecture only showing some elements and functional entities, all being logical units whose implementation may differ from what is shown. The connections shown in FIG. 1A are logical connections; the actual physical connections may be different. It is apparent to a person skilled in the art that the systems also comprise other functions and structures. It should be appreciated that the functions, structures, elements, and protocols used in or for group communication are irrelevant to the actual invention. Therefore, they need not be discussed in more detail here.

The exemplary radio system of FIG. 1A comprises a service core network 100.

The radio access network of the system comprises base stations that may also be called eNBs (Enhanced node Bs) 102 of the radio system. The base stations host the functions for Radio Resource Management: Radio Bearer Control, Radio Admission Control, Connection Mobility Control, Dynamic Resource Allocation (scheduling). The base stations 102 are connected to the core network 100.

FIG. 1A shows a mobile terminal 104 located in the service area of the eNodeB 102 and connected to the eNodeB 102. The mobile terminal 104 refers to a portable computing device. Such computing devices include wireless mobile communication devices operating with or without a subscriber identification module (SIM), including, but not limited to, the following types of devices: mobile phone, smartphone, personal digital assistant (PDA), handset, laptop computer.

In the example situation of FIG. 1A, the mobile terminal 104 has a connection 106 with the eNodeB 102. The connection 106 may relate to a call/a service which may be “long distance” where user traffic passes via the SAE GW 100. For example, a connection from the mobile terminal 104 to an external IP network, such as to the Internet, may be guided via the core network 100.

With reference to FIG. 1B, let us examine an example of a radio system to which embodiments of the invention can be applied. In this example, the radio system is based on UMTS (Universal Mobile Telecommunications System) network elements.

The example radio system of FIG. 1B comprises a core network 100 of an operator. The core network 100 is connected to the radio access network (RAN) of the UMTS. The RAN comprises a Radio Network Controller (RNC) 112 and a base station which may be called NodeB 114.

The mobile terminals 116 are connected via a radio connection 118 to the NodeB.

FIGS. 1A and 1B only illustrate simplified examples. In practice, the networks may include more base stations and radio network controllers, and more cells may be formed by the base stations. The networks of two or more operators may overlap, the sizes and form of the cells may vary from what is depicted in FIGS. 1A and 1B, etc.

It should be appreciated that the communication system may also comprise other core network elements besides SAE GW 100 or MSC 110. The embodiments are not restricted to the networks given above as an example, but a person skilled in the art may apply the solution to other communication networks provided with the necessary properties. For example, the connections between different network elements may be realized with Internet Protocol (IP) connections.

The mobile terminals which do not have an active (RRC-) connection to the networks they belong to are in idle mode. In idle mode, the terminals are able to receive system information and cell broadcast messages from a base station. For example, a base station may alert the mobile terminal due to an incoming call using a paging message. When a mobile terminal in idle mode moves to the service area of another base station, notable signalling does not occur. Only when an idle mode terminal crosses a larger traffic area boundary there is notable control traffic.

On the other hand, the mobile terminals having an active RRC connection to the network must perform a handover between base stations. This applies to mobile terminals having an on-going call or a data based connection with smaller amount of traffic yet requiring an active connection to the network. In communications networks such as UMTS and LTE, a base station or eNodeB may instruct a mobile terminal to perform given measurements when the terminal has an active connection with the network. The eNodeB task the mobile terminal UE to handle several “measurements objects” in parallel and assign specific actions, such as a regular report or an event triggered report to it. A measurement command including events and thresholds may be denoted as a measurement configuration. For example, the eNodeB may instruct the mobile terminal to measure the signal strengths of the serving eNodeB the mobile terminal is communicating with and the signal strengths of neighbour eNodeBs.

Examples of possible events of interest are:
Event A1 (Serving becomes better than threshold)
Event A2 (Serving becomes worse than threshold)
Event A3 (Neighbour becomes offset better than serving)
Event A4 (Neighbour becomes better than threshold)
Event A5 (Serving becomes worse than threshold1 and neighbour becomes better than threshold2).

The mobile terminal performs the measurements following the instructions by the serving eNodeB and reports the measurement results to the serving eNodeB either regularly or triggered by an event. The eNodeB may utilize the results when making handover decisions.

In an embodiment, the network comprises an apparatus configured to obtain information on the traffic characteristics of a mobile terminal and determine the value of a handover parameter for the mobile terminal on the basis of the traffic characteristics. The apparatus may be the serving eNodeB, an RNC connected to a nodeB serving the mobile terminal or some other network element connected to the base station serving the mobile terminal.

In an embodiment, the apparatus may be configured to obtain information on the traffic characteristics of a mobile terminal and information related to the movement of the mobile terminal, like the velocity of the mobile terminal and/or the moving direction. The apparatus may be configured to determine the value of a handover parameter for a mobile terminal on the basis of the traffic characteristics of the mobile terminal and the characteristics of the movement of the mobile terminal.

In an embodiment, the handover parameter is part of a measurement configuration command. The handover parameter may be a threshold value in a measurement configuration command.

In an embodiment, the handover parameter relates to the size of the serving area of the base station the mobile terminal is connected to. Thus, with suitable selection of the parameter the number of handovers and thus the signalling load in the network may be reduced.

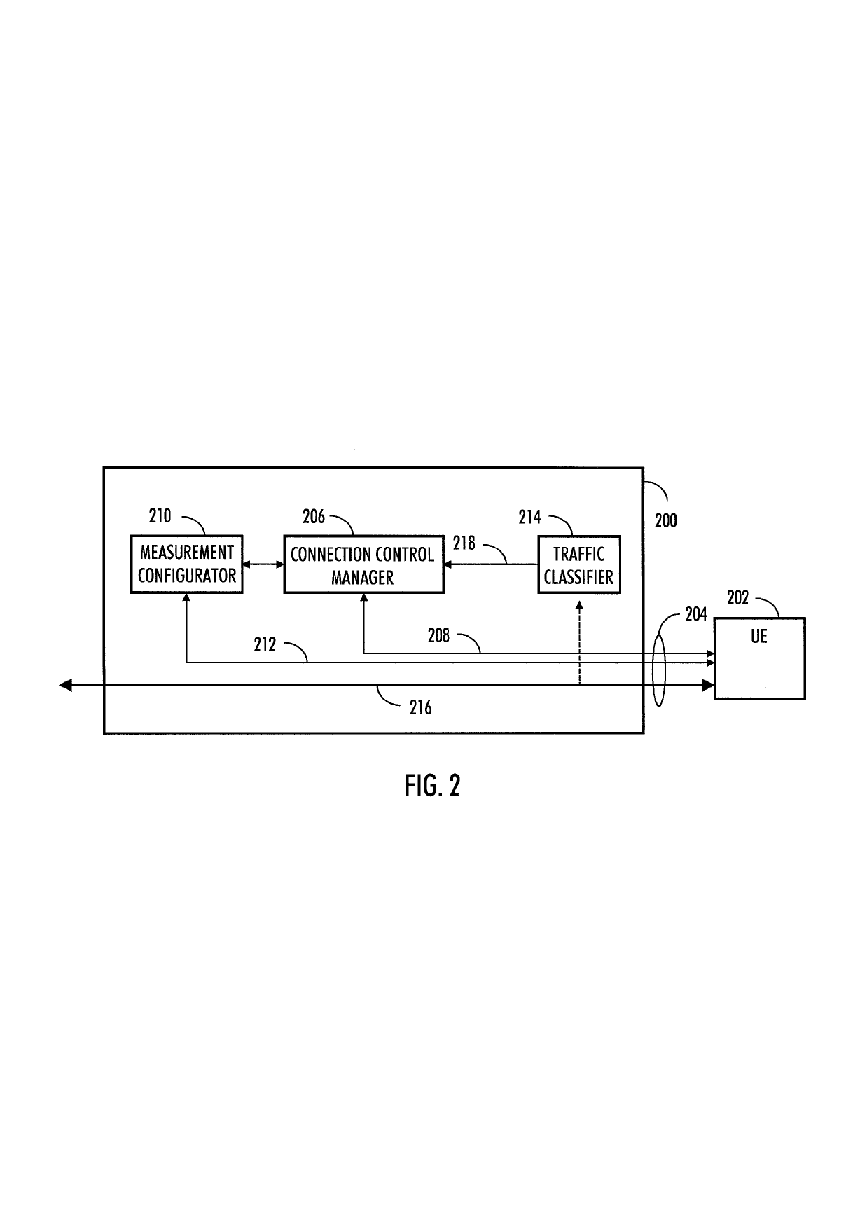

FIG. 2 illustrates an example of an apparatus of a network. The apparatus 200 is operationally connected 204 to a mobile terminal 202. The connection 204 may be a wireless connection or partly wireless and wired. The apparatus may comprise a connection control manager 206 configured to control 208 the mobility of the mobile terminal. The manager thus controls the mobile terminal to perform handovers when needed, for example. The apparatus further comprises a measurement configurator 210 configured to select the suitable measurement configuration for the mobile terminal and control the transmission of a measurement configuration 212 command to the mobile terminal. In an embodiment, the measurement configurator 210 may operate under the control of the connection control manager 206. In an embodiment, both connection control manager 206 and the measurement configurator 210 operate under a separate controller of the apparatus (not shown in FIG. 2). In an embodiment, the apparatus comprises a traffic classifier 214 configured to obtain information on the traffic 216 to and from the mobile terminal. The information on the traffic may comprise information on the traffic load/level and may be in the form of number of bytes per second, for example. Any other measurement unit relative to the amount of user traffic to and from the mobile terminal may be applied as well. The traffic value information may include information about waiting traffic such as queue lengths and scheduling requests which may chance the characteristics of the data traffic to/from the mobile station or, for how long time no traffic occurred. The traffic classifier may take into account also other internal traffic knowledge (control channel load or cell load in general). In an embodiment, the traffic classifier 214 is configured to obtain information related to the movement of the mobile terminal.

The traffic classifier may further take into account if data transmission/reception to/from the mobile terminal is going on continuously or if data packets are transmitted/received in the form of data bursts with notable and widely regular gaps between subsequent bursts.

The traffic classifier 214 may forward 218 the information related to the traffic to the connection control manager 206. On the basis of the information related to the traffic, the measurement configurator 210 may be controlled to send different measurement configuration commands to the mobile terminal in order to receive measurement reports from a mobile terminal when to initiate a handover procedure for the mobile terminal.

In an embodiment, the information related to the movement of a mobile terminal is also taken into account. Initiation of handover procedures may be done such that the number of needless handovers is minimized. A needless handover may in particular occur for a mobile terminal which is moving slowly (for instance pedestrian user) without clear direction of movement, with low data rate transmission and without continuous data transmission. In such a case, the degradation of the signal quality in the first serving cell may trigger a handover procedure to a neighbouring cell. But the signal qualities in both cells may stay comparable for a while since the mobile terminal is moving slowly. The mobile terminal may return after a short time to the area in which the first cell provides the best signal quality and only few data packets or even no data packet may have been transmitted in the neighbouring cell after the handover. Therefore the effort for handing over the mobile terminal forth and back will not pay off in terms of the experienced service quality and the handover procedure to the neighbouring cell should not have been initiated.

On the basis of the traffic level information, it is possible to detect which of those mobiles having an active connection are in having a high traffic connection and which have a low traffic connection. The connection control manager 206 may be configured to compare the obtained traffic level information to a given traffic level threshold. On the basis of the comparison, the measurement configurator 210 may be controlled to send following kinds of measurement configurations, for example:
MC1=Measurement configuration “Better Cell on”, suitable for the case that the mobile terminal has “high traffic” situation.
MC2=Measurement configuration “Better Cell off”, suitable for control traffic and small amounts of data. It shall trigger to preserve “reachability” within a cell.
MC3=Measurement configuration for immediate handover support.

Measurement configuration MC1 indicates when the handover is useful assuming the traffic level of the mobile terminal is above a given threshold. The measurement configuration may comprise an event triggered command to send a report to the serving base station when the signal strength of the serving base station becomes worse than a given threshold THR1. The threshold determines the cell radius for the mobile terminal. This may be coincident with the prior art cell radius for mobile terminal handovers. The overlap between adjacent cells is usually defined by the HO hysteresis for this situation to prevent ping-pong effects.

Measurement configuration MC2 indicates when the handover is useful assuming the traffic level of the mobile terminal is below a given threshold. The measurement configuration may comprise an event triggered command to send a report to the serving base station when the signal strength of the serving base station becomes worse than a given threshold THR2, where THR2 is smaller than THR1. Thus, the threshold determines the cell radius for the mobile terminal, where the cell radius is larger than in the case of MC1. MC2 indicates the larger radius where the mobile terminal still can be reached for signalling and small portions of data traffic. In this situation, the transmission of higher data volumes may not be advisable since the radio condition towards another base station is better. Still it is useful to keep the mobile terminal not performing a handover since it might be silent again for some minutes.

It may further be useful not to perform a handover when the expected service qualities before and after the handover for the next data trans-mission or the next data transmissions are alike. Therefore the traffic situation as set forth above for thresholds THR1 and THR2 may only be evaluated in the handover procedure when the velocity of the mobile terminal does not exceed a given threshold THR_V.

Measurement configuration MC3 instructs the mobile terminal to perform measurements immediately and report results to the network. This enables the network to decide whether an immediate handover is required or not. MC3 may comprise a measurement threshold, and the value of the threshold may be equal to the value defined in MC1. The MC3 configuration may be utilised to verify whether an immediate handover is needed or not for a terminal which is in MC2 state and which is experiencing traffic load transition from low to high. Therefore, the configuration MC3 may basically be similar to configuration MC1 but it need not be identical. The most likely difference will be the elapsed time for triggering a measurement report. This period may be shorter in MC3 in order to ensure a fast handover if needed.

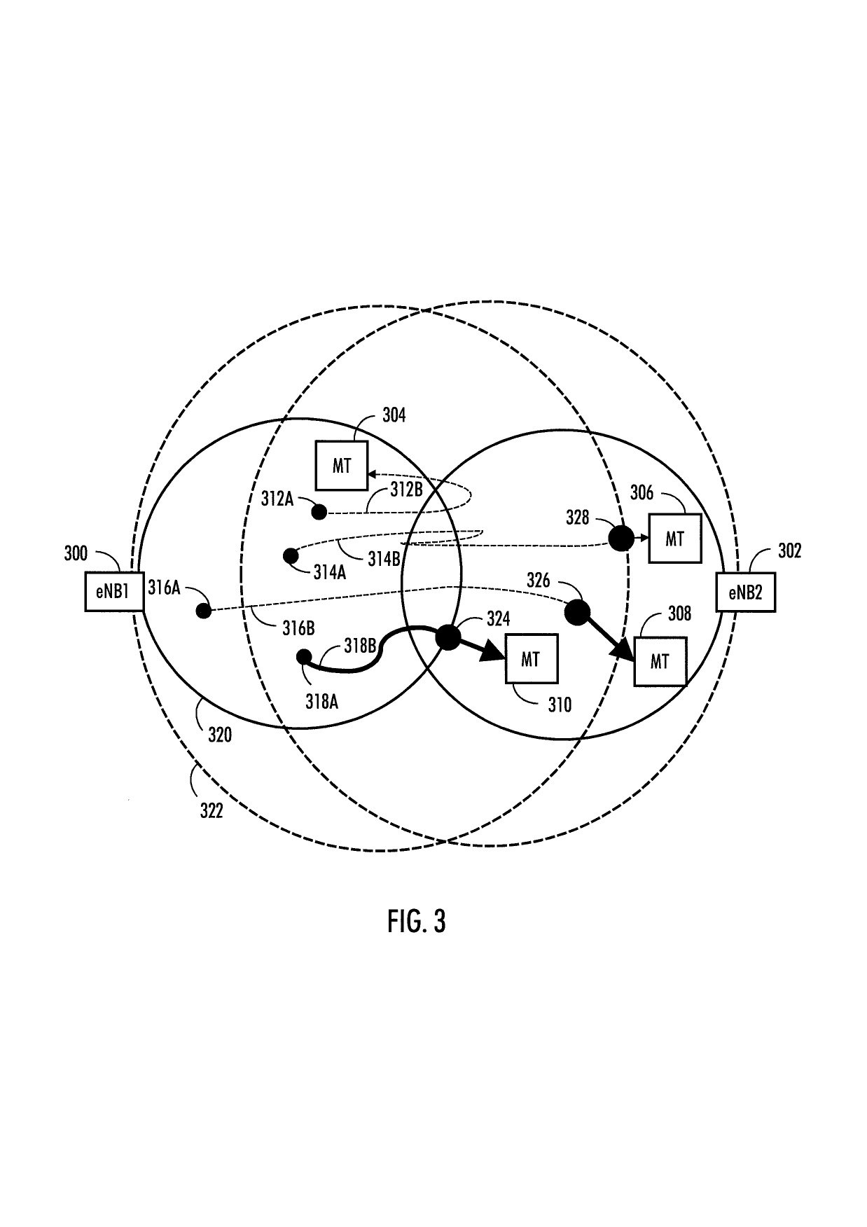

FIG. 3 illustrates an embodiment of the invention. FIG. 3 shows two eNodeBs 300, 302 and four mobile terminals 304, 306, 308 and 310. In the beginning, we may assume that the mobile terminals 304, 306, 308 and 310 are situated in points 312A, 314A, 316A and 318A, respectively and connected to eNodeB 300. Initially, the eNodeB 300 has scheduled MC1 for the mobile terminals. This measurement configuration may comprise event triggered reposting commands to the mobile terminal. All these mobile terminals have an active connection to the eNodeB. In the figure, the lines 312B, 314B, 316B and 318B indicate the routes of the mobile terminals. A hatched line type on a route indicates a moment in time when a mobile terminal is having a low traffic connection, i.e. a connection when the traffic level of the mobile terminal is below a given threshold. A solid line type on a route indicates a moment in time when a mobile terminal is having a high traffic connection, i.e. a connection when the traffic level of the mobile terminal is above a given threshold.

FIG. 3 illustrates the approximate cell radius corresponding to the threshold determined by MC1 as a circle 320. In practice, the cell radius is not a circle but just the boundary where the mobile terminal is triggered to report this event. The physical size of the cell depends upon many factors such as the terrain type and the number and size of obstacles such as buildings. Circle 322 illustrates an estimate of the cell boundary for a mobile terminal having configuration MC2 activated.

We assume here that mobile terminals move along the routes as indicated above. The mobile terminal 304 moves the route 312B originating from the point 312A. The mobile terminal 306 moves the route 314B originating from the point 314A. The mobile terminal 308 moves the route 316B originating from the point 316A. Correspondingly, the mobile terminal 310 moves the route 318B originating from the point 318A. As a mobile terminal reaches the cell border indicated by line 320, it transmits an event triggered report to the eNodeB 300. The traffic classifier 214 of the eNodeB 300 or some other apparatus in the network obtains information on the traffic level of each mobile terminals.

If a mobile terminal has traffic to send or to receive above a given traffic level threshold, a handover is performed normally and no further action required. In FIG. 3, the mobile terminal 310 is an example for this case. The traffic classifier 214 obtains information on the traffic level of the mobile terminal 310, and notifies the connection control manager 206 that the traffic level is above a given threshold. The connection control manager 206 commands the mobile terminal 310 to perform a handover to eNodeB 304 at point 324. If the traffic level of a mobile terminal is below a given traffic level threshold, a handover is not performed, even though is has an RRC connection to the eNodeB 300. Instead, the connection control manager 206 controls the measurement configurator 210 to activate measurement configuration MC2 at the mobile terminal. The mobile terminals 304, 306 and 308 are in this kind of situation. A handover is not yet performed although the cell border is reached. The handover is delayed until either the traffic classifier 214 detects that the traffic level of the mobile terminal increases above given traffic level or the mobile terminal triggers an MC2 event, such as low signal level from the eNodeB. In the former case, a handover is required if the mobile terminal is still outside of the “inner” cell radius 320. If the mobile terminal has already returned into the area 320, no handover need to be performed at all, but MC1 may be re-activated, instead.

In FIG. 3, the mobile terminal 308 is an example of the former case. At point 326, the traffic level of the mobile terminal increases due to a phone call, for example. A handover to eNodeB 302 may be required to guarantee quality of service. To get an overview about the current radio condition in this moment of time, the connection control manager requests the terminal to perform MC3 measurement immediately to prepare the handover (or find out that no HO is required). The mobile terminal 306 is an example of the latter case. As the mobile terminal reaches point 328 the MC2 trigger indicates such radio conditions that a handover to eNodeB 302 is required also for low traffic situation and a handover is performed to prevent loss of the control of this terminal. As a result of this procedure, a certain number of mobile terminals communicating with eNodeB 300 will be allowed to move outside of the original cell definition without having performed a handover procedure. For those returning back into MC1 coverage 320 a handover can be completely avoided. In FIG. 3, the mobile terminal 304 is an example of this. In addition, handover of the mobile terminal 306 may be postponed.

Thus, depending of the actual mobility of a mobile terminal, handover procedures can be avoided in some of the situations. The degree of handover reduction versus the cost of a slightly worse interference situation can be controlled on a per-cell level by setting the thresholds in a suitable manner.

In an embodiment, greater overlapping cell areas are created for mobile terminals having a low traffic level connection compared to mobile terminals having a high traffic level connection. Especially for low data rate communication, the robustness against bad signal to noise ration (SINR) is much better than compared to a high-data-rate transmission situation.

In an embodiment, the connection control manager 206 controls the measurement configurator 210 to activate measurement configuration MC1 at the mobile terminals which feature a traffic level above a given traffic level and to activate measurement configuration MC2 at those mobile terminals which feature a traffic level below the given traffic level. According to this embodiment, only the mobile terminals with a traffic level above the given threshold will send event triggered reports to the eNodeB 300 when they reach the cell border indicated by the line 320.

In an embodiment, the connection control manager 206 controls the measurement configurator 210 to activate measurement configuration MC1 at the mobile terminals which feature a traffic level above a given traffic level or above a given velocity threshold and to activate measurement configuration MC2 at those mobile terminals which feature a traffic level below the given traffic level and a velocity below the given velocity threshold. According to this embodiment, the mobile terminals with a traffic level above the given threshold or a velocity above the given velocity threshold will send event triggered reports to the eNodeB 300 when they reach the cell border indicated by the line 320.

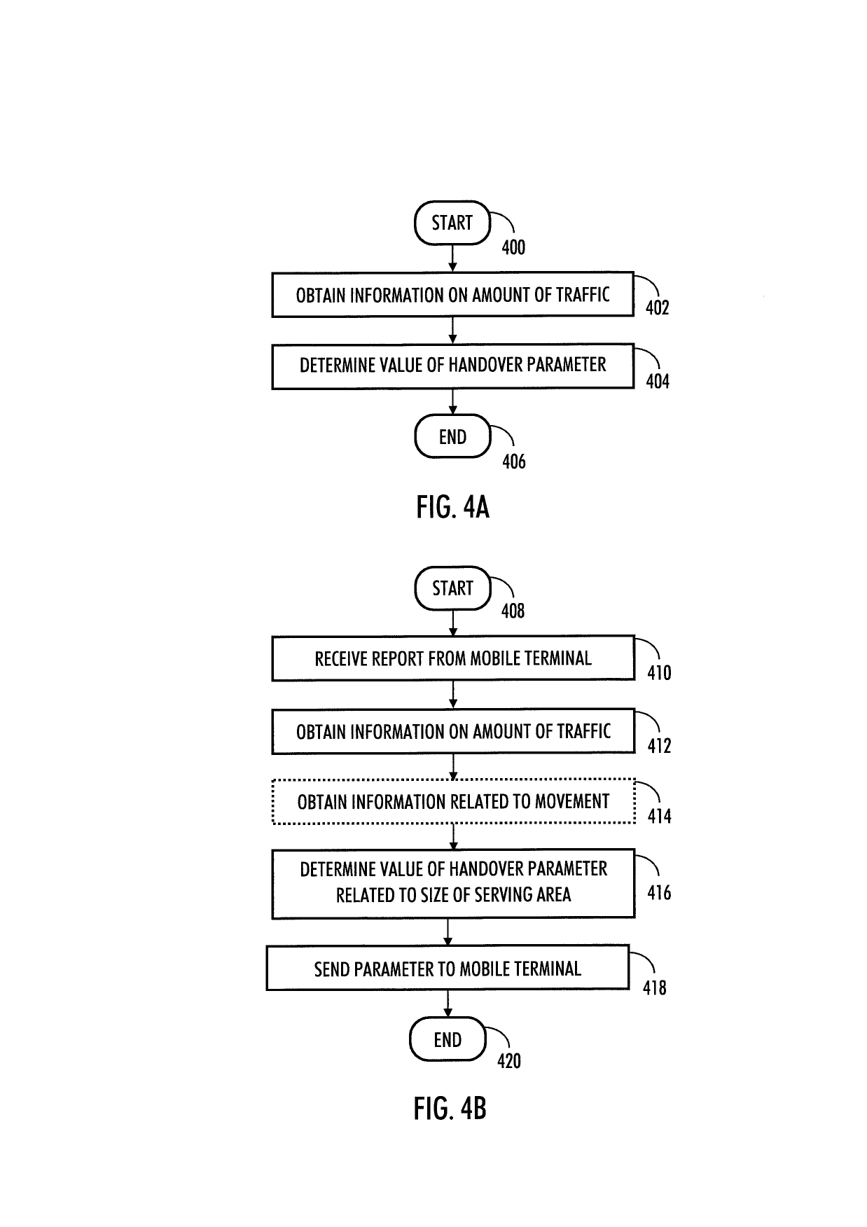

FIG. 4A is a flow chart illustrating an embodiment. The embodiment starts at step 400.

In step 402, information on the amount of traffic of a mobile terminal is obtained.

In step 404, the value of a handover parameter for the mobile terminal on the basis of the traffic level is determined.

The embodiment ends at step 406.

FIG. 4B is a more detailed flow chart illustrating an embodiment. The embodiment starts at step 408.

In step 410, an event triggered report is received from a mobile terminal. This may indicate that the mobile terminal has reached cell border 320.

In step 412, information on the amount of the traffic level of the mobile terminal is obtained. The information may be obtained by monitoring the traffic to and from the mobile terminal. The monitoring may be performed by a traffic classifier 214.

In an embodiment, information related to the movement of the mobile terminal is obtained in step 414. utilise the information when determining the value of a handover parameter for the mobile terminal.

In step 416, the value of a handover parameter related to the size of the serving area of the network element the mobile terminal is connected to is determined. In an embodiment this determination is made in a connection control manager 206. In an embodiment, the value of the parameter is determined on the basis of the traffic level. In an embodiment, the information related to the movement of the mobile terminal is taken into account. The handover parameter may be a threshold value in an event triggered measurement report command.

In step 418, information on the handover parameter is sent to the mobile terminal. In an embodiment, the information is sent by a measurement configurator 210. In an embodiment, the information is included in a measurement configuration command as a threshold value. The value of the handover parameter may be selected from a predetermined number of values. For example, there may be a given number of different measurement configuration commands from which one is selected on the basis of the traffic level of the mobile terminal.

The embodiment ends at step 420.

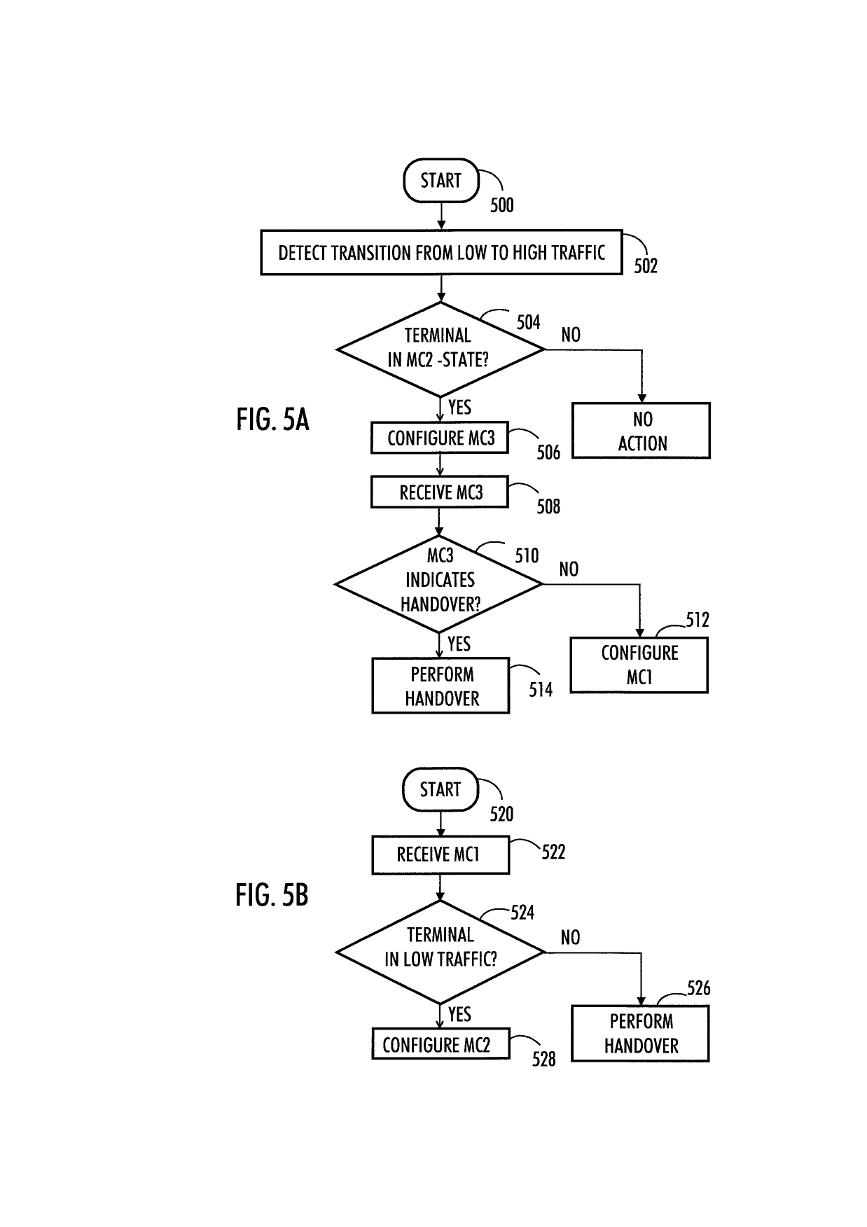

FIG. 5A illustrates an embodiment. The mobile terminal 308 of FIG. 3 is an example of this embodiment. The embodiment starts at step 500

In step 502, the traffic classifier 214 detects that the traffic level of a mobile terminal has increased and is now above a given threshold. Thus, the mobile terminal has moved from “low traffic” situation to “high traffic” situation.

In step 504, the network determines the measurement configuration of the mobile terminal. If the mobile terminal is not in MC2 state, then immediate action is not required. The measurement configuration MC1 will take care of any handover needs.

If the mobile terminal is in MC2 state, the measurement configurator 210 activates MC3 at the mobile terminal in step 506. Thus, the mobile terminal is to perform measurements and report the results to the network so that the need for a handover may be detected. When a terminal is in MC2 state and roams around, the network has no knowledge of the actual location of the terminal. The terminal may be inside of the MC1 circle 320, or it may be inside the MC2 circle 322. In the first case, a handover is not required whereas in the second case a handover may be needed to guarantee quality of the connection. Activating MC3 at a mobile terminal is a way to determine the signal level received by the mobile terminal. In an embodiment, threshold associated with MC3 may be the same as with MC1, the difference being in that in the former case measurements are required to be performed immediately.

In step 508, the network receives the MC3 related measurements.

In step 510, the need for a handover is determined. The decision may be based on the signal levels reported by the mobile terminal, for example. If MC3 equals MC1, this step may be omitted. If a handover is not required, the measurement configurator 210 activates MC1 at the mobile terminal in step 512. Otherwise, a handover is performed in step 514.

FIG. 5B illustrates an embodiment. The embodiment starts at step 520

In step 522, the network receives MC1 report from a mobile terminal. The mobile terminal has thus reached the MC1 border 320.

In step 524, the traffic classifier 214 obtains information on the amount of traffic of a mobile terminal and determines whether the mobile terminal is in a low traffic situation or not.

If the mobile terminal is not in a low traffic situation (like the mobile terminal 310 in FIG. 3) the connection control manager 206 controls the mobile terminal to perform a handover in step 526.

If the mobile terminal is in a low traffic situation, the connection control manager 206 controls the measurement configurator 210 to activate measurement configuration MC2 at the mobile terminal in step 528.

The above steps may be performed by an eNodeB or a radio network controller, for example. The steps may be performed in whole or at least in part by other network elements of participating systems.

The steps, signalling messages and related functions described in the attached figures are in no absolute chronological order, and some of the steps may be performed simultaneously or in an order differing from the given one. Other functions can also be executed between the steps or within the steps and other signalling messages sent between the illustrated steps. Some of the steps can also be left out or replaced with a corresponding step.

The apparatuses or controllers able to perform the above-described steps may be implemented as an electronic digital computer, which may comprise a working memory (RAM), a central processing unit (CPU), and a system clock. The CPU may comprise a set of registers, an arithmetic logic unit, and a controller. The controller is controlled by a sequence of program instructions transferred to the CPU from the RAM. The controller may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

An embodiment provides a computer program embodied on a distribution medium, comprising program instructions which, when loaded into an electronic apparatus, are configured to control the apparatus to execute the embodiments described above.

The computer program may be in source code form, object code form, or in some intermediate form, and it may be stored in some sort of carrier, which may be any entity or device capable of carrying the program. Such carriers include a record medium, computer memory, read-only memory, an electrical carrier signal, a telecommunications signal, and a software distribution package, for example. Depending on the processing power needed, the computer program may be executed in a single electronic digital computer or it may be distributed amongst a number of computers.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

It will be obvious to a person skilled in the art that, as technology advances, the inventive concept can be implemented in various ways. The invention and its embodiments are not limited to the examples described above but may vary within the scope of the claims.

1. An apparatus, comprising:
at least one processor and at least one memory including a computer program code, wherein the at least one memory and the computer program code are configured to, with the at least one processor, cause the apparatus at least to:
obtain information on the amount of traffic of a mobile terminal and
determine the value of a handover parameter for the mobile terminal on the basis of the traffic level.

2. The apparatus of claim 1, wherein the apparatus is configured to determine the value of a handover parameter related to the size of the serving area of the network element the mobile terminal is connected to.

3. The apparatus of claim 2, further configured to determine a value related to a larger cell size for a mobile terminal having a traffic level below a given threshold than for a mobile terminal having a traffic level above the given threshold.

4. The apparatus of claim 1, wherein the apparatus is configured to select the value of the handover parameter from a predetermined number of values.

5. The apparatus of claim 1, wherein the handover parameter is part of a measurement configuration command.

6. The apparatus of claim 1, wherein the handover parameter is a threshold value in an event triggered measurement report command.

7. The apparatus of claim 1, the apparatus being configured to send the mobile terminal information on the handover parameter.

8. The apparatus of claim 1, wherein the apparatus is configured to obtain information related to the movement of a mobile terminal and utilise the information when determining the value of a handover parameter for the mobile terminal.

9. The apparatus of claim 1, wherein the apparatus is configured to receive an event triggered report from a mobile terminal prior to obtaining information on the amount of traffic of the mobile terminal.

10. A method comprising:
obtaining information on the amount of traffic of a mobile terminal and
determining the value of a handover parameter for the mobile terminal on the basis of the traffic level.

11. The method of claim 10, further comprising:
determining the value of a handover parameter related to the size of the serving area of the network element the mobile terminal is connected to.

12. The method of claim 10, further comprising:
determining a value related to a larger cell size for a mobile terminal having a traffic level below a given threshold than for a mobile terminal having a traffic level above the given threshold.

13. The method of claim 10, further comprising: selecting the value of the handover parameter from a predetermined number of values.

14. The method of claim 10, wherein the handover parameter is part of a measurement configuration command.

15. The method of claim 10, wherein the handover parameter is a threshold value in an event triggered measurement report command.

16. The method of claim 10, further comprising: sending the mobile terminal information on the handover parameter.

17. The method of claim 10, further comprising:
obtaining information related to the movement of a mobile terminal and
utilising the information when determining the value of a handover parameter for the mobile terminal.

18. The method of claim 10, further comprising:
receiving an event triggered report from a mobile terminal prior to obtaining information on the amount of traffic of the mobile terminal.

19. A computer program embodied on a distribution medium, comprising program instructions which, when loaded into an electronic apparatus, are configured to control the apparatus to
obtain information on the amount of traffic of a mobile terminal and
determine the value of a handover parameter for the mobile terminal on the basis of the traffic level.

20. (canceled)

21. An apparatus, comprising:
means for obtaining information on the amount of traffic of a mobile terminal and means for determining the value of a handover parameter for the mobile terminal on the basis of the traffic level.

22. (canceled)
